(19) United States
(12) Patent Application Publication
(10) Pub. No.: US 2012/0121977 A1
(43) Pub. Date: May 17, 2012

(54) Surface-modified silicon anode active material, method of preparing the same, and anode and lithium battery employing the same

(75) Inventors: WANLI XU, BATON ROUGE, LA (US); JOHN C. FLAKE, BATON ROUGE, LA (US)

(73) Assignee: Electrochemical Materials, LLC, BATON ROUGE, LA (US)

(21) Appl. No.: 13/338,062

(22) Filed: Dec. 27, 2011

(51) Int. Cl. H01M 10/056; H01M 4/62; H01M 4/134; H01M 4/38; H01M 4/13

(52) U.S. Cl. 429/207; 252/182.1; 429/212; 429/218.1; 429/231.5; 429/217

(57) ABSTRACT

An anode active material comprising silicon particles with an interfacial layer formed on the surface of the silicon is provided. The interfacial layer has good electron conductivity, elasticity and adhesion among anode materials, thereby enhancing anode capacity and reducing stress caused by expansion of silicon particles during charge and discharge cycles. Direct contact between silicon particles and electrolyte is remarkably reduced as well. In addition, anodes and lithium batteries including the anode active material exhibit excellent capacity and cycle efficiency.

### BACKGROUND OF THE INVENTION

1. Field of Invention

The present invention relates to an anode active material comprising silicon particles and an interfacial layer formed on the silicon particle surface, an anode comprising the anode active material, a lithium ion rechargeable battery, a method of creating the interfacial layer on the silicon particle surface, a method of fabricating the anode, a method of fabricating the lithium rechargeable cell.

2. Description of the Related Art

Carbonaceous materials are used as anode materials in conventional lithium rechargeable batteries. Recently, silicon has become a promising candidate to replace carbonaceous materials as anode for rechargeable lithium ion batteries. It has been reported that silicon, which has the vast theoretical capacity for lithium storage at 4200 mAh·g⁻¹, is over ten times higher than that of conventional carbonaceous material adopted in commercial lithium rechargeable batteries. However, the phenomenon of significant volume increase upon lithium insertion have been observed for bulk silicon, along with the cracking and pulverization associated with the charge and discharge cycles, has prohibited its use in practice.

Continuous research efforts in silicon anodes for lithium ion batteries have resulted in limited success. Composite anodes with silicon particles and other active and inactive materials have been applied in lithium rechargeable batteries. Recent literature with nano-scale silicon in lithium ion cells, including silicon nanowires, structured silicon particles, 3-D structured silicon nanoclusters, and etc., have shown that near theoretical capacities are achievable; unfortunately, capacity losses remain significant.

Thus, there exists an ongoing need for an anode material for use in lithium ion batteries having improved capacity and cycling efficiency.

### SUMMARY OF THE INVENTION

In one embodiment of the present invention, an anode active material includes silicon particles and an interfacial layer formed on at least a portion of the silicon particles.

In another embodiment of the present invention, a method that modifies the silicon surface by creating the interfacial layer on the silicon particles.

In yet another embodiment of the present invention, an anode includes the anode active material. The anode is comprised of the anode active material, carbonaceous materials, a binder, and a current collector.

In still another embodiment of the present invention, a lithium ion rechargeable battery includes the anode, a cathode, and a non-aqueous electrolyte.

### BRIEF DESCRIPTION OF THE DRAWING

The invention may be more completely understood in consideration of the detailed description of various embodiments of the invention that follows in connection with the accompany drawings, in which:

FIG. 1 shows an anode for lithium ion battery comprising the anode active material comprising silicon particles with an interfacial layer, carbonaceous materials, and a polymer binder.

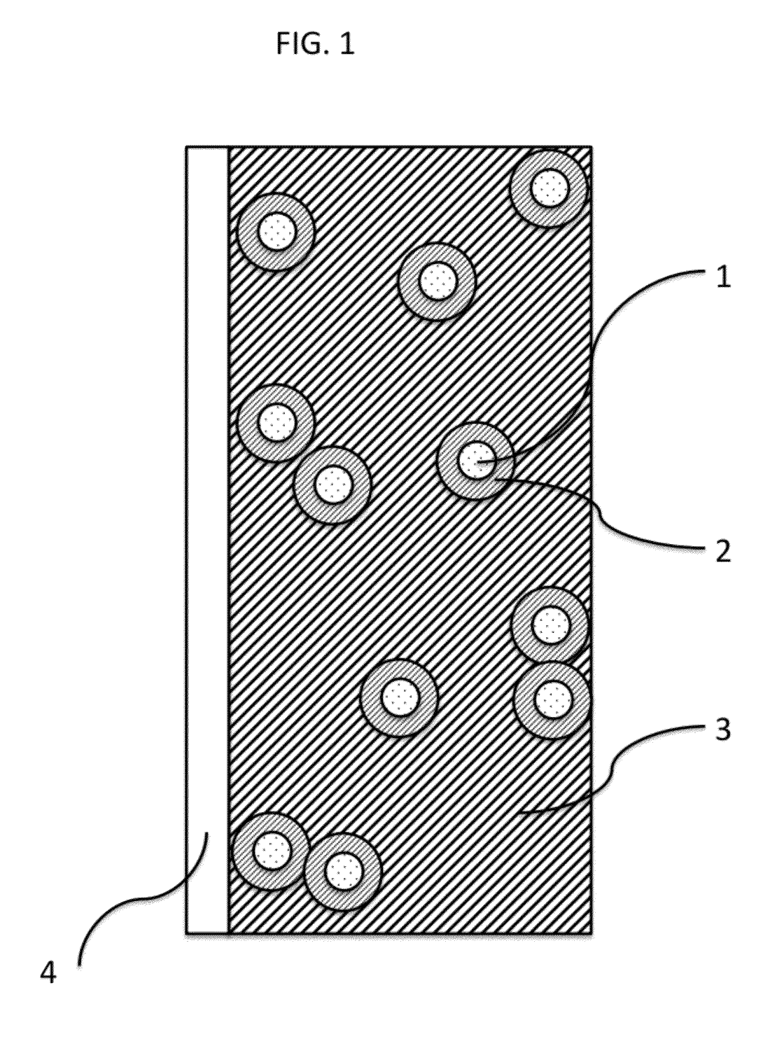

FIG. 2 shows a scanning electron microscopy image of an example anode surface.

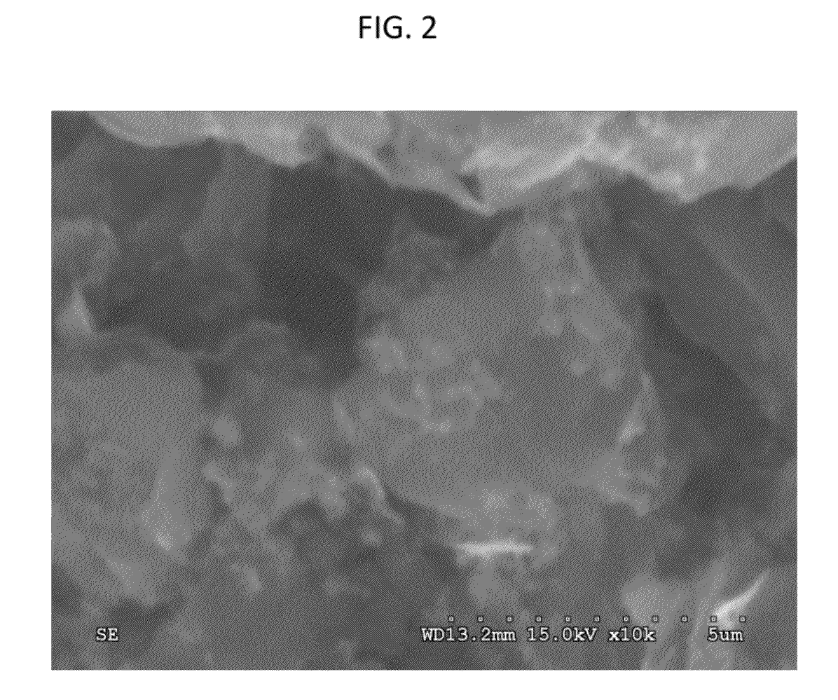

FIG. 3 shows a graph of the charge and discharge capacities as well as coulombic efficiencies versus cycle number for an example anode.

While the invention is amenable to various modifications and alternative forms, examples thereof have been shown by way of example in the drawing and will be described in detail. It should be understood, however, that the intention is not to limit the invention to the particular embodiments shown and/or described. The intention is to cover all modifications, equivalents, and alternatives falling within the spirit and scope of the invention.

### DETAILED DESCRIPTION OF THE INVENTION

The present invention is believed to be applicable to a variety of different types of lithium rechargeable batteries and devices and arrangement involving silicon composite electrodes. While the present invention is not necessarily limited, various aspects of the invention may be appreciated through a discussion of example using the context.

Silicon anode active material includes silicon particles with a purity of 95-99 wt. %. The silicon particles may be in various shapes, including spheres, hemispheres, pillars, wires, clusters, and etc. The size and distribution of silicon particles may be varied, but within a preferred range from 10 nanometers to 10 micrometers and a more preferred range from 50 nanometers to 300 nanometers.

According to one embodiment of the present invention, the interfacial layer may be a monolayer or multilayer that covers at least 75% of the silicon particle surface with a more preferred coverage of over 95%. The interfacial layer is present in the anode active material amount ranging from about 0.1 to about 5 wt. % based on the total weight of the anode active material.

According to one embodiment of the present invention, the interfacial layer that can be described as the surface silicon atom bonded to a group R, where R is one of the following surface groups, including an atom: e.g., a hydrogen atom, a halogen atom, a oxygen atom, a carbon atom, a nitrogen atom; a monomer functional group: e.g., a hydroxyl group, a amide group, a amine group, and etc.; and a polymer functional group: e.g., a substitute or unsubstitute of C₁₋₂₀ alkyl group, a substitute or unsubstitute of C₁₋₂₀ alkoxy group, a substitute or unsubstitute of C₁₋₂₀ halogenoalkyl group, a substitute or unsubstitute of C₁₋₂₀ alkylsiloxane group, a substitute or unsubstitute of C₁₋₂₀ alkenyl group, a substitute or unsubstitute of C₁₋₂₀ carbonyl group, a substitute or unsubstitute of C₁₋₂₀ hydroxyl carbonyl group, a substitute or unsubstitute of C₆₋₃₀ aryl group, a substitute or unsubstitute of C₆₋₃₀ aryloxy group, a substitute or unsubstitute of C₂₋₃₀ heteroaryl group, a substitute or unsubstitute of C₂₋₃₀ heteroaryloxy group, and etc.

In one embodiment, the interfacial layer formation on silicon particles may be achieve without limitation through a variety of methods, including thermal deposition, electrochemical deposition, photoelectrochemical deposition, chemical treatment, physical treatment, and etc. The interfacial layer formation on silicon particles occurs prior to applying the silicon particles into an anode for lithium rechargeable batteries.

In another embodiment, an anode for lithium rechargeable batteries comprising the anode active material can be fabricated. The anode active material comprising silicon particles and the interfacial layer may be embedded into carbonaceous materials and binder matrix to form the anode.

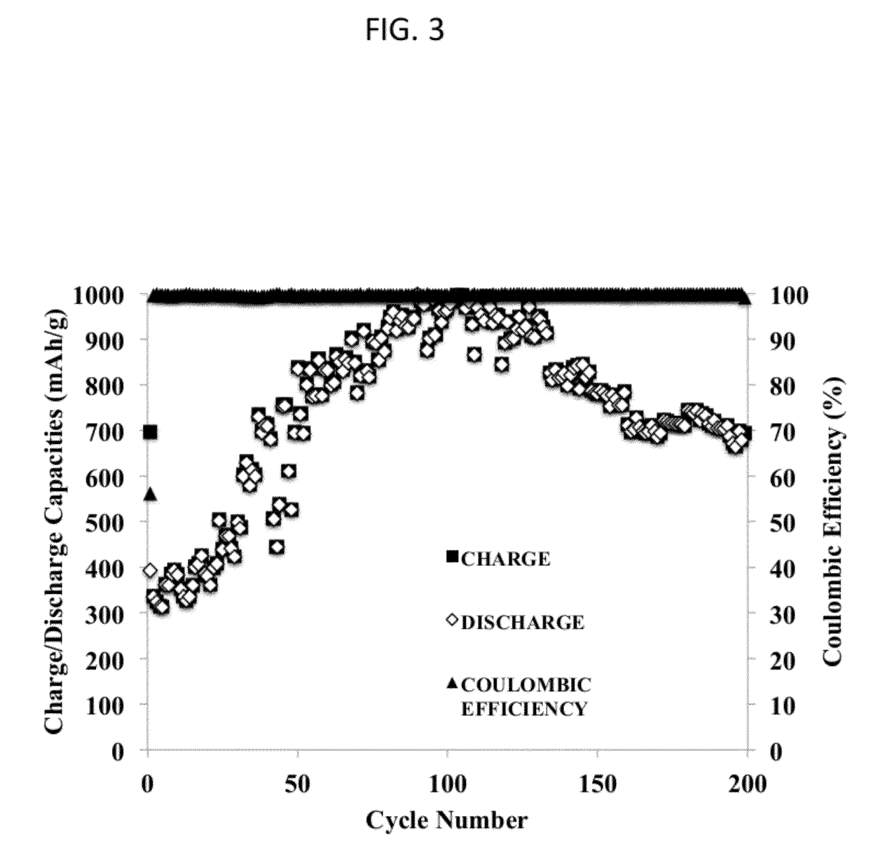

In connection with another embodiment of the present invention, an arrangement for use in a battery is implemented. The arrangement includes that the anode active material is mixed with carbonaceous materials and a polymer binder. The carbonaceous materials may be obtained from various sources, examples of which may include but not limited to petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The binder may be, but not limited to, polyvinylidene fluoride, sodium carboxymethyl cellulose, styrene-butadiene rubber, and etc. The mix comprising the anode active material, carbonaceous materials, and the binder can be applied to a current collector. The current collector can be metallic copper film with a preferred thickness of 10 micrometers to 100 micrometers. In this fashion, the arrangement can be used as an anode in a lithium rechargeable battery. FIG. 3 shows the anode comprising the anode active material comprising silicon particle 1 and an interfacial film 2 embedded into carbonaceous materials and binder matrix 3 on the current collector 4.

Consistent with one embodiment of the present invention, a battery is implemented with the anode, a cathode, a separator and a non-aqueous electrolyte. The cathode is comprised of lithium salts such as lithium manganese oxide, lithium cobalt oxide, lithium ion phosphate, and etc.; carbonaceous materials, and a polymer binder. The non-aqueous electrolyte can be a mixture of a lithium compound and an organic carbonate solution. The lithium compound may be, but not limited to lithium hexafluorophosphate, lithium perchloride, lithium bix(oxatlato)borate, and etc. The separator membrane can be a multiple polymer membrane. The organic solution may be comprised of but not limited to any combination of the following species: ethylene carbonate, dimethyl carbonate, diethyl carbonate, propylene carbonate, vinylene carbonate, and etc.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof The examples are given by way of illustration only and are not intended to limit the specification or the claims in any manner. The following illustrates exemplary details as well as characteristics of such surface modified silicon particles as the active anode materials for lithium ion batteries.

A liquid suspension mixture was prepared by dispersing 0.5 grams of silicon nanoparticles (average particles size below 100 nanometer) in 10 milliliters methanol. 1.25 milliliter 5% n(acetylglycyl)-3-aminopropyltrimethoxysilane solution in methanol was introduced into the suspension. A resulting mixture is heated at 75° C. with continuous agitation and sufficient ventilation until dry. The dried mix was cured at 120° C. for 12 hours afterwards. The dried mix was cooled to ambient temperature and then well mixed with 0.5 grams of carbon black (average particle size below 50 nanometer), 3.5 grams of natural graphite (average particle size below 40 micrometer), and 10 milliliters 5 w.t. % polyvinylidene fluoride in n-methylpyrrolidone solution. The resulting mix was applied to a copper foil (˜25 micrometer in thickness) via doctor blade method to deposit a layer of anode approximately 100 micrometers in thickness. The film was then dried in vacuum at 120° C. for 24 hours.

The sample was assembled and evaluated as an anode in lithium rechargeable coin cell CR2032 with pure lithium metal as the other electrode. A disk of 1.86 cm² was punched out from the film as the anode, and the anode active material weight is approximately 5 micrograms. The other electrode is a lithium metal disk with a thickness of 250 micrometers and the same surface area as the anode. Microporous trilayer membrane (Celgard 2320) was used as separator between the two electrodes. Approximately 1 milliliter 1 molar per liter LiPF₆ in a solvent mix comprising ethylene carbonate and dimethyl carbonate with 1:1 volume ratio was used as electrolyte in the lithium cell. All above experiments were carried out in glove box system under argon atmosphere with less then 1 part per million water and oxygen.

The assembled lithium coin cell was taken out of the glove box and stored in ambient condition for another 24 hours prior to testing. The coin cell was charged and discharged at a constant current of 0.5 mA, and the charge and discharge rate is approximately C/5 from 0.05 V to 1.5 V versus lithium for 200 cycles at ambient temperature.

FIG. 4 shows capacities of the sample anode over 200 charge and discharge cycles. Reversible capacity of approximately 700 mAh·g⁻¹ (approximate 80% of theoretical capacity) Scan be obtained after 200 cycles with coulombic efficiency over 99%.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. It is the intent of the inventors that variations and equivalents of the invention are with in the scope of the claims below and the description, abstract and drawings are not to be used to limit the scope of the invention.

What is claimed is:

1. An anode active material comprising: silicon particles and an interfacial layer formed on at least a portion of a surface of the silicon particles.

2. The anode active material of claim 1, wherein the silicon particles are 10 nanometers to 10 micrometers in diameter with a more preferred diameter range from 50 nanometers to 300 nanometers.

3. The anode active material of claim 1, wherein the interfacial layer is present on substantially the entire surface of the. silicon particles. The interfacial layer is a monolayer that covers at least 75% of the silicon particle surface with a more preferred coverage of over 95%.

4. The anode active material of claim 1, wherein the interfacial layer is present in the anode active material in an amount ranging from about 0.1 to about 5 wt. % based on the total weight of the anode active material.

5. The anode active material of claim 1, wherein the interfacial layer that can be described as the surface silicon atom bonded to a surface group R, where R can be one of the following, including a single atom, a monomer, and a polymer.

6. The anode active material of claim 1, therein the R group is one of the following surface groups, including an atom: e.g., a hydrogen atom, a halogen atom, a oxygen atom, a carbon atom, a nitrogen atom; a monomer functional group: e.g., a hydroxyl group, a amide group, a amine group, and etc.; and a polymer functional group: e.g., a substitute or unsubstitute of C₁₋₂₀ alkyl group, a substitute or unsubstitute of C₁₋₂₀ alkoxy group, a substitute or unsubstitute of C₁₋₂₀ halogenoalkyl group, a substitute or unsubstitute of C₁₋₂₀ alkylsiloxane group, a substitute or unsubstitute of C₁₋₂₀ alkenyl group, a substitute or unsubstitute of C₁₋₂₀ carbonyl group, a substitute or unsubstitute of C₁₋₂₀ hydroxyl carbonyl group, a substitute or unsubstitute of C₆₋₃₀ aryl group, a substitute or unsubstitute of C₆₋₃₀ aryloxy group, a substitute or unsubstitute of C₂₋₃₀ heteroaryl group, a substitute or unsubstitute of C₂₋₃₀ heteroaryloxy group, and etc.

7. An composite anode comprising: the silicon particles with an interfacial layer formed on at least a portion of a surface of the silicon particle, other anode active materials, carbonaceous materials, and a binder.

8. The anode of claim 7, wherein the anode active material comprising silicon particles with an interfacial layer is present in the anode in an amount with a preferred range from 5 to 30 wt. % and a more preferred range from 15 to 20 wt. % based on the total weight of the anode.

9. The anode of claim 7, wherein the other anode active materials can be a variety of materials that can reversibly store lithium, such as titanate, germanium, and etc.

10. The anode of claim 7, wherein the carbonaceous materials can be from a variety of carbon sources, including graphite, carbon black, pitch, acetylene black, and etc.

11. The anode of claim 7, wherein the binder can be polyvinylidene fluoride, sodium carboxymethyl cellulose, styrene-butadiene rubber, and etc.

12. An energy storage device, comprising the anode according to claim 6, a cathode, an electrolyte, and a separator between the anode and the cathode.

13. The energy storage device of claim 12, wherein the cathode is comprised of lithium salts such as lithium manganese oxide, lithium cobalt oxide, lithium ion phosphate, and etc; carbonaceous materials, a polymer binder, and a current collector.

14. The energy storage device of claim 12, wherein the electrolyte can be a mixture of a lithium salt and an organic compound.

15. The energy storage device of claim 12, wherein the separator is a microporous polymer membrane.
